(19) United States
(12) Patent Application Publication
(10) Pub. No.: US 2011/0136484 A1
(43) Pub. Date: Jun. 9, 2011

(54) USER ADMISSION, POWER, RATE AND MOBILITY CONTROL METHOD FOR RELAY COMMUNICATION SYSTEMS

(76) Inventors: Volker Braun, Stuttgart (DE); Pantelis Monogioudis, Randolph, NJ (US)

(21) Appl. No.: 12/953,975

(22) Filed: Nov. 24, 2010

Related U.S. Application Data
(60) Provisional application No. 61/267,303, filed on Dec. 7, 2009.

(51) Int. Cl. H04W 24/00; H04W 52/26

(52) U.S. Cl. 455/422.1

(57) ABSTRACT

In one embodiment, a request is sent to a relay node (RN) requesting the RN to perform a signal measurement operation. The request includes an indication to measure a signal strength of a link between the RN and a user equipment (UE). A signal measurement value is received from relay node, a determination on whether to associate the UE with the RN is made based on the signal measurement value.

### PRIORITY INFORMATION

This U.S. non-provisional patent application claims priority under 35 U.S.C. §119 of U.S. provisional patent application No. 61/267,303, filed on Dec. 7, 2009, the entire contents of which are incorporated herein by reference.

### BACKGROUND OF THE INVENTION

1. Field

Example embodiments of the present invention relate generally to wireless networks including relay nodes.

2. Related Art

Some wireless networks include relay nodes (RN) which work in conjunction with base stations (BS), for example extended node Bs (enB), to extend the coverage of the BSs. One type of RN is the type II RN defined by 3GPP documents for LTE-Advanced technology.

A simple example of downlink operation of a type II relay, integrated into a hybrid automatic repeat request (HARQ) operation is described below. An eNB sends a transport block to a UE and RN. The RN successfully decodes the transport block, while UE fails to decode the transport block. The RN retransmits the transport block at some later time, possibly simultaneously with eNB, and the UE receives the transport block correctly because the channel quality on the RN-UE link is significantly better than on the eNB-UE link. Accordingly, the manner in which RNs are used in wireless networks to supplement the wireless coverage of BSs can affect the quality of service experienced by UEs in a wireless network.

### SUMMARY

One or more embodiments relate to method and apparatus for handling association of a user equipment (UE) in a communications network including a base station (BS) and a relay node (RN).

According to one embodiment, a method for handling association of a user equipment (UE) in a communications network including a base station (BS) and a first relay node (RN) may include sending a request to the first RN for the first RN to perform a signal measurement operation, the request including an indication to measure at least one of a signal strength and signal quality of a link between the RN and the UE. A first signal measurement value may be received from the first RN, and it may be determined whether to associate the UE with the first RN based on the first signal measurement value.

The request may be a request for the RN to perform a signal measurement operation based on data received at the RN from the UE, the data including one or more sounding reference signal (SRS) values.

The request may be a request for the RN to perform a signal measurement operation based on data received at the RN from the UE, the data including pilot signals received in at least one of a physical uplink control channel (PUCCH) or a physical uplink shared channel (PUSCH).

A comparison result may be generated based on the first signal measurement value and a threshold, wherein the determining step includes determining whether to associate the UE with the first RN based on the comparison result.

An indication may be sent to the first RN to serve the UE, if the determining step determines to associate the UE with the first RN; and a power command may be sent to the UE instructing the UE to reduce a transmit power of the UE, if the determining step determines to associate the UE with the first RN.

A signal measurement operation may be performed at the BS measuring at least one of a signal strength and signal quality of a link between the RN and the UE; and a second signal measurement value may be generated based on the signal measurement operation performed at the BS. A difference value may be generated based on a difference between the first signal measurement value and the second signal measurement value, wherein the generating the comparison result step includes generating the comparison result based on the difference value and the threshold.

An indication may be sent to the first RN to serve the UE, if the determining step determines to associate the UE with the first RN; and a power command may be sent to the UE instructing the UE to reduce a transmit power of the UE, if the determining step determines to associate the UE with the first RN.

The power command may include instructions for the UE to reduce the transmit power of the UE by an amount determined based on the difference value.

The first RN may be one of a plurality of RNs included in the communications network, the sending step may include sending a request to each of the plurality of RNs for each of the plurality of RNs to perform signal measurement operations, and the receiving step may include receiving a first signal measurement value from each of the plurality of RNs. The generating a comparison result step may include generating a plurality of comparison results based on the first signal measurement values for each of the plurality of RNs and the threshold, and the determining step may include determining whether to associate the UE with one or more selected RNs from among the plurality of RNs based on the plurality of comparison results.

Serve indications may be sent to the one or more RNs the determining step determined to associate the UE with, each serve indication indicating the RN is to serve the UE; and a power command may be sent to the UE instructing the UE to reduce a transmit power of the UE, if the determining step determines to associate the UE with at least one of the selected RNs.

The first RN may be a type II RN.

According to another example embodiment, a method for handling association of a user equipment (UE) in a communications network including a base station (BS) and a relay node (RN) may include receiving a request from the BS requesting the RN to pedai in a signal measurement operation, the request including an indication to measure a signal strength of a link between the RN and the UE; receiving a quality/strength indicator from the UE; performing the signal measurement operation based on the quality/strength indicator to generate a signal measurement value; and sending the signal measurement value to the base station.

An indication to serve the UE may be received from the BS at the RN based on the signal measurement value sent from the RN to the BS. The UE may be served by performing at least one of forwarding communications data received from the BS to the UE and forwarding communications data received from the UE to the BS.

The signal measurement value may be compared to a threshold value at the RN; and it may be determined whether to serve the UE based on the comparison at the RN. An indication of the determination may be sent from the RN to the BS; and data may be received for the UE from the BS at the RN if the indication indicates the RN determined to serve the UE.

The quality/strength indicator may include one or more sounding reference signals (SRS) values.

The quality/strength indicator may include one or more pilot signals received in at least one of a physical uplink control channel (PUCCH) or a physical uplink shared channel (PUSCH).

According to another example embodiment, a method for handling association of a user equipment (UE) in a communications network including a base station (BS) and a relay node (RN) may include sending a signal quality/strength indicator; receiving, at the UE from the BS, an indication to reduce a transmit power level of the UE, the indication being based on a signal measurement performed at the RN based on the signal quality/strength indicator; and reducing the transmit power at the UE based on the indication.

The signal quality/strength indicator may include one or more sounding reference signal (SRS) values.

According to yet another example embodiment, a network apparatus for providing wireless communications between a base station (BS) and a user equipment (UE) in a wireless communications network may include a receiver unit configured to receive data from the BS and the UE; a transmitting unit configured to transmit data to the BS and the UE; a memory unit configured to store parameters corresponding with at least one of signal power and signal quality measurements associated with the wireless communications network; and a processing unit. The processing unit may be coupled to the transmitting unit, the receiving unit, and the memory unit and configured to control operations associated with evaluating at least one of the signal quality and the signal strength including, receiving a request from the BS requesting the RN to perform a signal measurement operation, the request including an indication to measure at least one of a signal strength and a signal quality of a link between the RN and the UE, receiving a quality/strength indicator from the UE, performing the signal measurement operation based on the quality/strength indicator to generate a signal measurement value, and sending the signal measurement value to the BS.

### BRIEF DESCRIPTION OF THE DRAWINGS

Example embodiments of the present invention will become more fully understood from the detailed description provided below and the accompanying drawings, wherein like elements are represented by like reference numerals, which are given by way of illustration only and thus are not limiting of the present invention and wherein:

FIG. 1A is a diagram illustrating a portion of a communications network.

FIG. 1B is a diagram illustrating an example of a relay node (RN) according to an example embodiment.

FIG. 2A is a flow chart illustrating a process for determining whether to associate a UE with a relay node according to an example embodiment from the viewpoint of a base station (BS).

FIG. 2B is an example of sounding reference signals (SRS) and their position in an uplink subframe.

FIG. 2C is a flow chart illustrating a process for determining whether to associate a UE with one of a plurality of relay nodes according to an example embodiment from the viewpoint of a BS.

FIG. 3A is a flow chart illustrating a process for determining whether to associate a UE with a RN according to an example embodiment from the viewpoint of the first RN.

FIG. 3B is a flow chart illustrating a process for determining whether to associate a UE with a relay node (RN) according to an example embodiment from the viewpoint of the first RN.

FIG. 4 is a flow chart illustrating a process for determining whether to associate a UE with a relay node according to an example embodiment from the viewpoint of the UE.

FIG. 5 is a communications flow diagram illustrating a process of handling a mobile terminated call according to an example embodiment.

### DETAILED DESCRIPTION OF EXAMPLE EMBODIMENTS

Various example embodiments of the present invention will now be described more fully with reference to the accompanying drawings in which some example embodiments of the invention are shown.

Detailed illustrative embodiments of the present invention are disclosed herein. However, specific structural and functional details disclosed herein are merely representative for purposes of describing example embodiments of the present invention. This invention may, however, be embodied in many alternate forms and should not be construed as limited to only the embodiments set forth herein.

Accordingly, while example embodiments of the invention are capable of various modifications and alternative fo ms, embodiments thereof are shown by way of example in the drawings and will herein be described in detail. It should be understood, however, that there is no intent to limit example embodiments of the invention to the particular forms disclosed, but on the contrary, example embodiments of the invention are to cover all modifications, equivalents, and alternatives falling within the scope of the invention. Like numbers refer to like elements throughout the description of the figures. As used herein, the term “and/or” includes any and all combinations of one or more of the associated listed items.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (e.g., “between” versus “directly between”, “adjacent” versus “directly adjacent”, etc.).

The terminology used herein is for the purpose of describing particular embodiments only and is not intended to be limiting of example embodiments of the invention. As used herein, the singular forms “a”, “an” and “the” are intended to include the plural font's as well, unless the context clearly indicates otherwise. It will be further understood that the thin's “comprises”, “comprising,”, “includes” and/or “including”, when used herein, specify the presence of stated features, integers, steps, operations, elements, and/or components, but do not preclude the presence or addition of one or more other features, integers, steps, operations, elements, components, and/or groups thereof.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

As used herein, the term user equipment (UE) may be considered synonymous to, and may hereafter be occasionally referred to, as a terminal, mobile unit, mobile station, mobile user, access terminal (AT), subscriber, user, remote station, access terminal, receiver, etc., and may describe a remote user of wireless resources in a wireless communication network. The term base station (BS) may be considered synonymous to and/or referred to as a base transceiver station (BTS), NodeB, extended Node B (eNB), femto cell, access point, etc. and may describe equipment that provides the radio baseband functions for data and/or voice connectivity between a network and one or more users.

Exemplary embodiments are discussed herein as being implemented in a suitable computing environment. Although not required, exemplary embodiments will be described in the general context of computer-executable instructions, such as program modules or functional processes, being executed by one or more computer processors or CPUs. Generally, program modules or functional processes include routines, programs, objects, components, data structures, etc. that perfoims particular tasks or implement particular abstract data types.

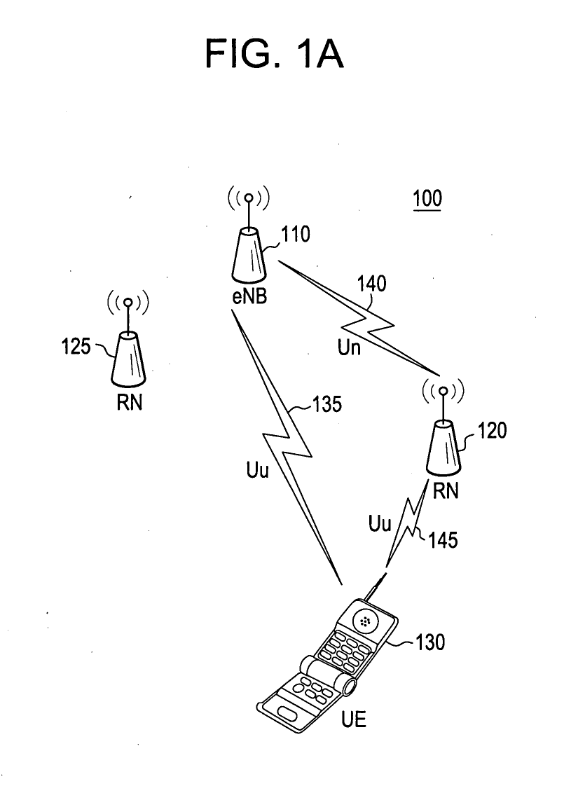

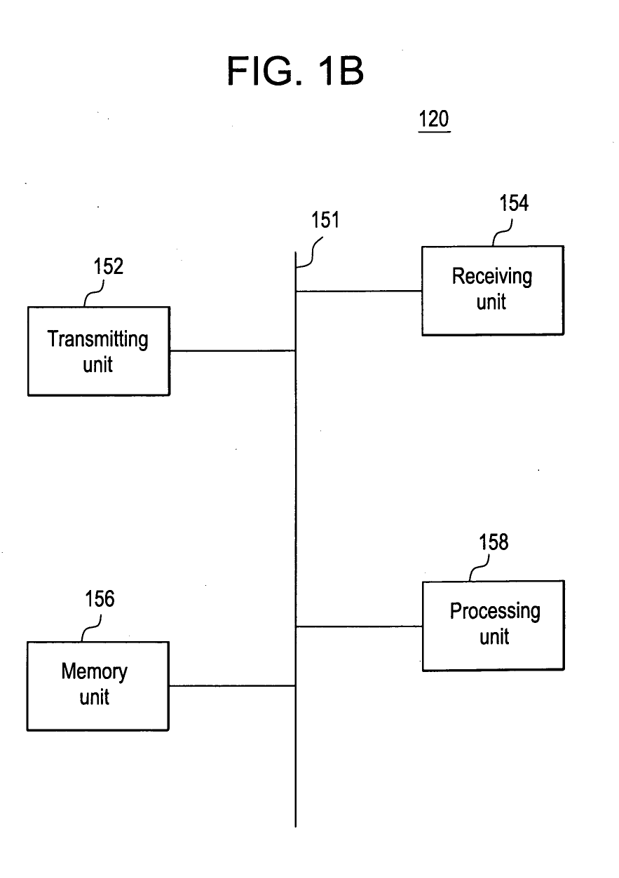

The program modules and functional processes discussed herein may be implemented using existing hardware in existing communication networks. For example, program modules and functional processes discussed herein may be implemented using existing hardware at existing network elements or control nodes (e.g., a BS or relay node (RN) shown in FIG. 1). Such existing hardware may include one or more digital signal processors (DSPs), application-specific-integrated-circuits, field programmable gate arrays (FPGAs) computers or the like.

In the following description, illustrative embodiments will be described with reference to acts and symbolic representations of operations (e.g., in the faun of flowcharts) that are performed by one or more processors, unless indicated otherwise. As such, it will be understood that such acts and operations, which are at times referred to as being computer-executed, include the manipulation by the processor of electrical signals representing data in a structured form. This manipulation transforms the data or maintains it at locations in the memory system of the computer, which reconfigures or otherwise alters the operation of the computer in a manner well understood by those skilled in the art.

FIG. 1A illustrates a portion of a communications network 100. Referring to FIG. 1, communications network 100 may follow, for example, an LIE protocol. Communications network 100 includes a base station (BS) 110; first and second relay nodes (RNs) 120 and 125; and a UE 130. Though, for the purpose of simplicity, communications network 110 is illustrated as having only BS 110; first RN 120; second RN 125; and UE 130, communications network 100 may have any number of BSs, RNs and UEs. Further, communications network 100 may include other network elements which are not illustrated for put poses of simplicity. For example, the BS 110, first RN 120, and second RN 125 may be connected to, for example, one or more mobility management entities (MME) (not shown) included in the communications network 100. The first and second RNs 120 and 125 are located at different locations but may operate in the same manner.

Accordingly, for the purpose of simplicity, FIG. 1A will be described below with reference only to the first RN 120.

The BS 110 may be, for example, an evolved node B (eNB) providing wireless coverage for UEs within a coverage area of the BS 110, for example the UE 130. The BS 110 and the UE 130 may communicate through a wireless link 135. The wireless link 135 may be, for example, a Uu type link. The BS 110 may also communicate with one or more RNs within a coverage area of the BS 110, for example the first RN 120. In the example illustrated in FIG. 1, the first RN 120 is associated with the BS 110. The BS 110 and the first RN 120 may communicate through a wireless link 140. The wireless link 140 may be, for example, a Un type link.

The first RN 120 may provide wireless coverage for UEs, for example the UE 130, within a coverage area of the first RN 120 that supplements coverage provided by the BS 110. The first RN 120 may communicate with UEs including the UE 130 through a wireless link 145. The wireless link 145 may be, for example, a Uu type link. For example, the first RN 120 may relay information received from the UE 130 via the wireless link 145 to the BS 110 via the wireless link 140, and relay information received from the BS 110 via the wireless connection 140 to UE 130 via the wireless link 145. The UE 130 may be, for example, a Rel-8 UE as defined by 3GPP standards.

The first RN 120 may be, an RN that conforms to the requirements of a type II RN as defined by the 3GPP documents. According to 3GPP LTE-Advanced documents, a type II RN may have characteristics as described below. A type II RN may not have a separate physical cell ID and thus would not create any new cells. A type II RN may be transparent to UEs, for example, a Rel-8 UE as defined by 3GPP standards, and thus UEs are not aware of the presence of a type II RN. The type II RN can transmit over the physical downlink shared channel (PDSCH). A type II RN, may not transmit cell specific reference signals (CRS), or transmit over the physical downlink shared channel (PDCCH). An example structure of an RN according to an example embodiment will be discussed in greater detail below with reference to FIG. 1B.

UEs, for example the UE 130, within coverage areas of both the BS 110 and the first RN 120 may be in communication with the BS 100 through either a direct wireless connection to the BS 110 via wireless connection 135, or through a wireless connection to the first RN 120 via wireless links 140 and 145. In either case, the presence of the first RN 120 may not be apparent to the UE 130.

A UE within communication network 100 may be closer to the first RN 120 than the UE is to the BS 110. Accordingly, an amount of transmit power necessary to for the UE to communicate at an acceptable quality level with the BS 110 through a direct wireless connection with the BS 110 may be greater than an amount of transmit power necessary for a UE to communicate at an acceptable quality level with the BS 110 through a wireless connection with the first RN 120. It would be advantageous to choose an RN serve a UE such that the UE could communicate with a BS through the RN, as opposed to a direct connection with the BS, when doing so would reduce the amount of transmit power necessary for the UE to communicate with the BS.

Conventional UE association techniques are based on handover measurements, i.e. a UE measures the strength or SINR of pilot signals transmitted by a network node, for example a BS, and feeds back the measurement results to the network node, so the network can decide which network node to serve the UE. However, due to the absence of cell specific pilot signals, a UE cannot make signal strength measurements with respect to type II RN. Accordingly, conventional mechanisms are not suitable for determining whether or not to associate a UE with a type II RN.

As will be discussed in greater detail below, according to an example embodiment, signal quality and/or power estimates for a link between an RN and a UE may be made at an RN using uplink signals received at the RN from the UE and forwarded to a BS in order to allow the BS to make intelligent decisions regarding whether to associate a UE with the RN. An example of an RN implementing the functions discussed above will be explained in greater detail below with reference to FIG. 1B.

Overview of Method and Apparatus for Determining Whether to Associate a UE with a Relay Node

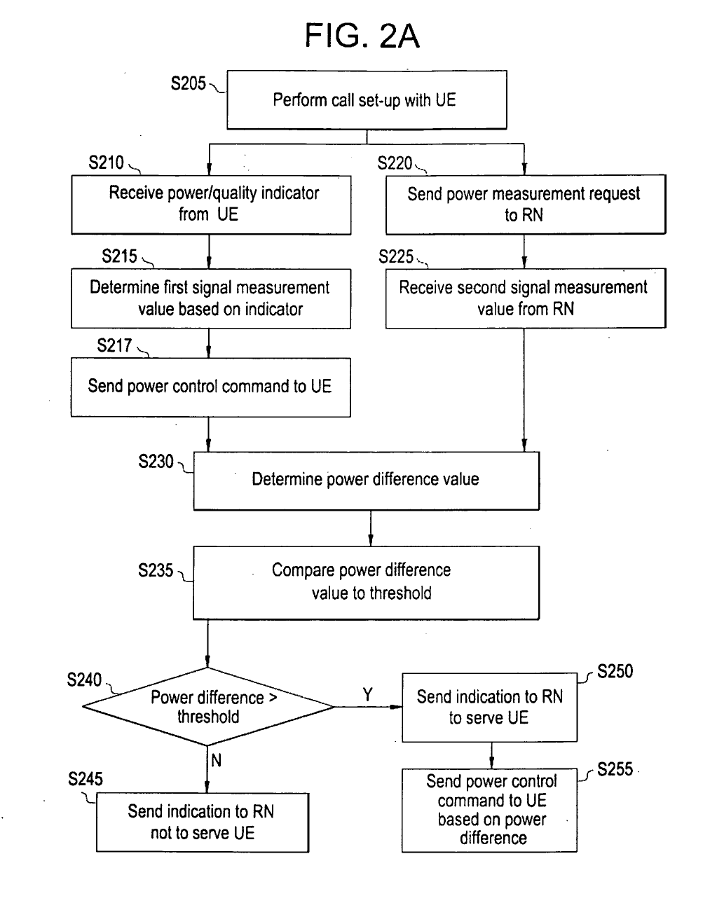

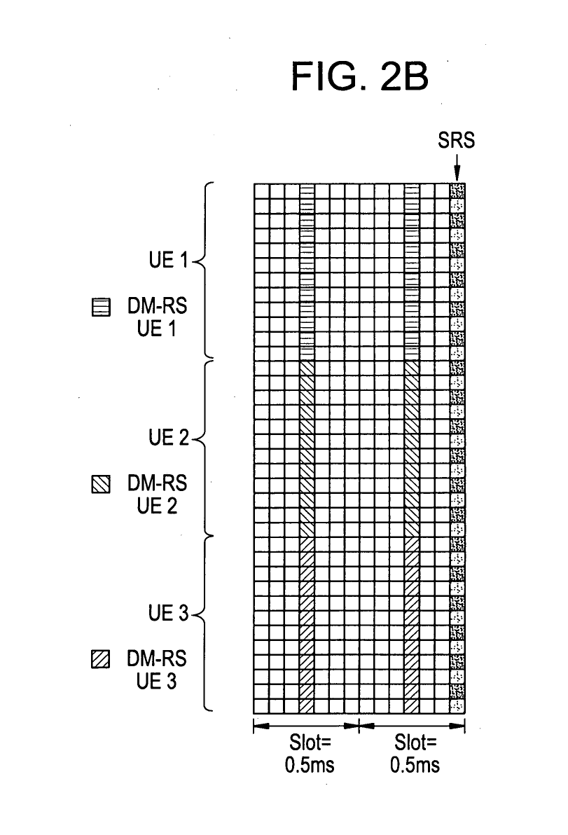

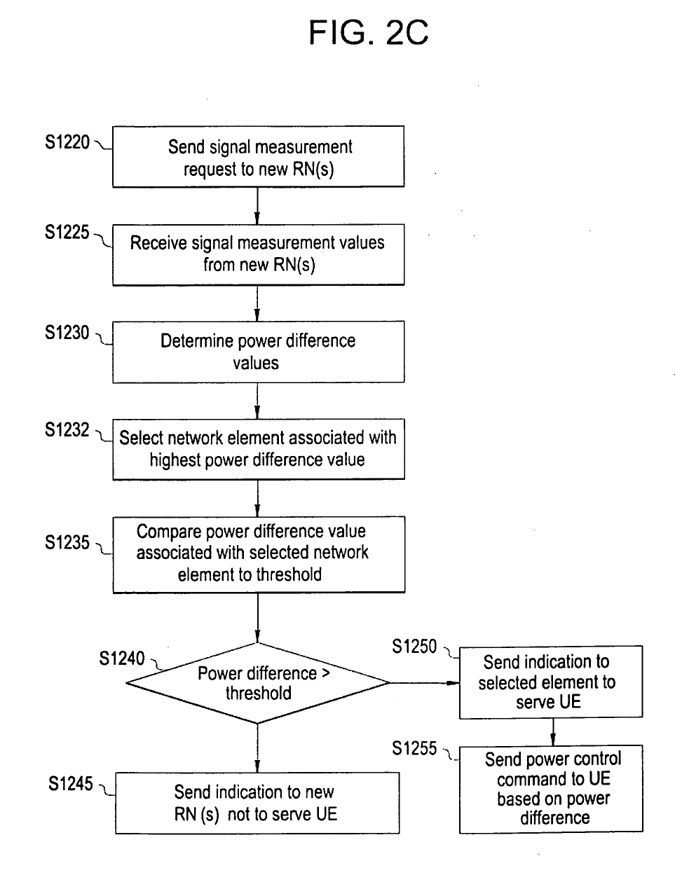

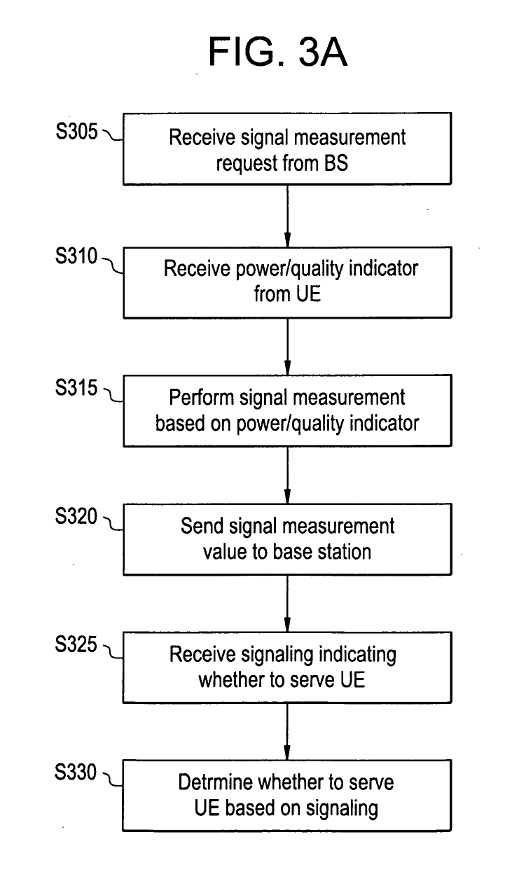

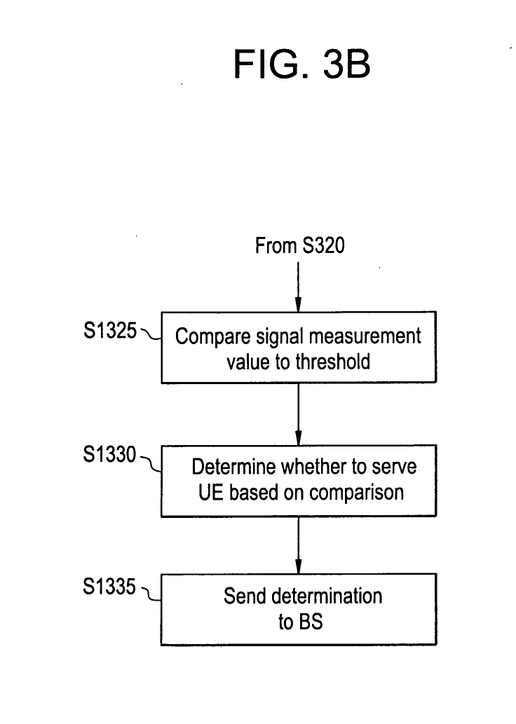

FIG. 1B is a diagram illustrating an example structure of the RN 120 according to an example embodiment. Referring to FIG. 1B, the relay node 120 may include, for example, a data bus 151, a transmitting unit 152, a receiving unit 154, a memory unit 156, and a processing unit 158. The transmitting unit 152, receiving unit 154, memory unit 156, and processing unit 158 may send data to and/or receive data from one another using the data bus 151. The transmitting unit 152 is a device that includes hardware and any necessary software for transmitting wireless signals including, for example, data signals, control signals, and signal strength/quality information via one or more wireless connections to other network elements in communications network 100. The receiving unit 154 is device that includes hardware and any necessary software for receiving wireless signals including, for example, data signals, control signals, and signal strength/quality information via one or more wireless connections to other network elements in communications network 100. The memory unit 156 may be any device capable of storing data including magnetic storage, flash storage, etc. The processing unit 158 may be any device capable of processing data including, for example, a microprocessor configured to carry out specific operations based on input data, or capable of executing instructions included in computer readable code. For example, the processing unit 158 is capable of performing signal strength/quality estimates based on signal strength/quality indicators received from a UE or a BS, and performing comparisons based on the signal strength/quality estimates. An example method for operating the RN 120 will be discussed in greater detail below with reference to FIGS. 3A and 3B. Processes for determining whether to associate a UE with a relay node will now be discussed in greater detail below with reference to FIGS. 2-5.

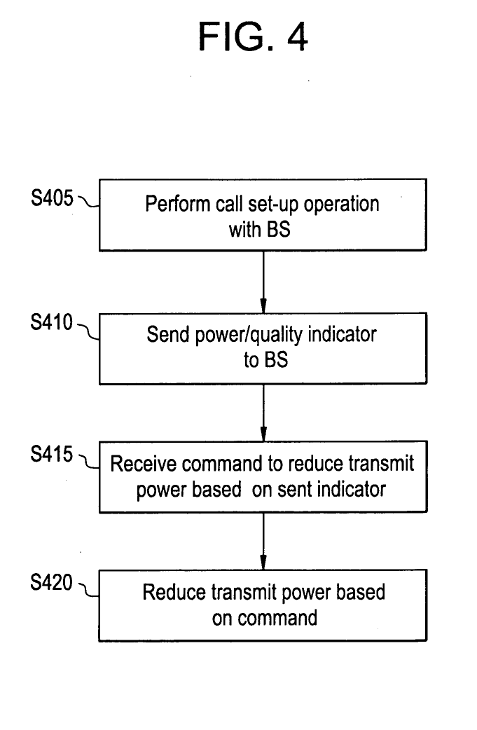

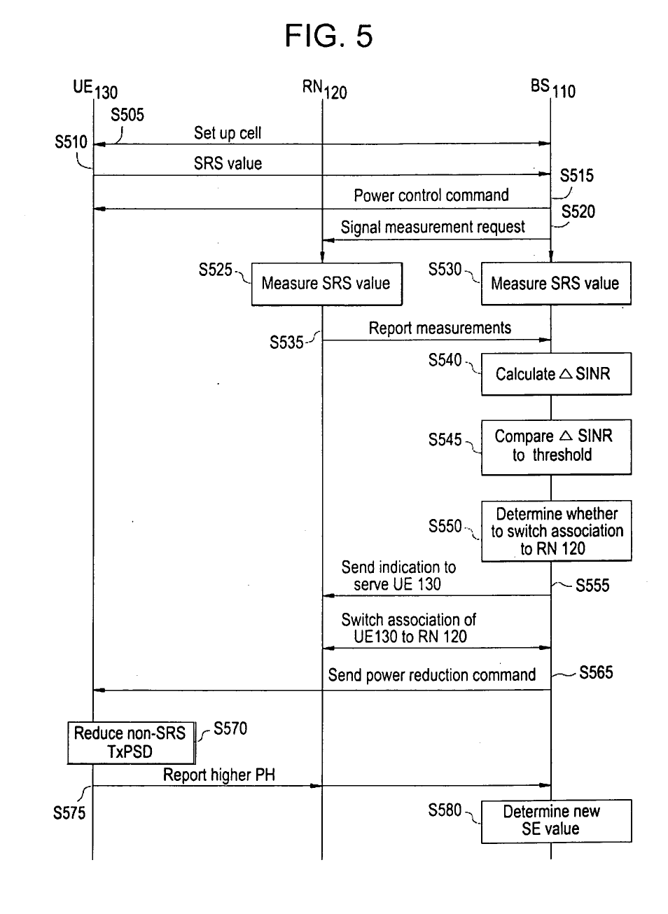

Processes for determining whether to associate a UE with a relay node according to an example embodiment will now be discussed with reference to the communications network 100 illustrated in FIG. 1A. Examples of the process will be discussed in four parts. First, examples of the process will be discussed from the view point of the BS 110 with reference to FIGS. 2A-C. Second, examples of the process will be discussed from the view point of the first RN 120 in FIGS. 3A and 3B. Third, examples of the process will be discussed from the view point of the UE 130 in FIG. 4. Fourth, an example operation sequence of a process for determining whether to associate a UE with a relay node according to an example embodiment will be discussed with reference to FIG. 5.

In the examples discussed below with reference to FIGS. 2-5, it may be assumed that a central scheduling scheme is used, and thus scheduling is under control of BS 110; the first RN 120 and second RN 125 may transmit and receive in different subframes; and uplink (UL) signals transmitted by UE may be power controlled, under control of the BS 110. Further, a time advance applied by the UE 130 for UL transmission may be under control of BS 110. Further, the first RN 120 may be a priori informed by the BS 110 about the cell ID and all other relevant cell-specific radio parameters such as frame timing, system bandwidth, number of transmit antennas, allocation and generation of sounding reference signals etc., associated with the cell of the BS 110. Further, the first RN 120 may be configured by the BS 110 to be in receiving mode in some subframes and in transmitting mode in other subframes, for example periodically with 10 ms period in correspondence with frame timing.

### Operation of BS

FIG. 2A is a flow chart illustrating a process for determining whether to associate a UE with a relay node according to an example embodiment from the viewpoint of BS 110. Referring to FIG. 2A, in step S205 the BS 110 performs a call set up operation with the UE 130 according to known methods.

In step S210, the BS receives a quality/strength indicator from the UE 130. The quality/strength indicator may be, for example, an indicator of at least one of a signal strength and a signal quality for the link 145 between the UE 145 and the RN 120. For example, the quality/strength indicator may be a sounding reference signal (SRS) sent by the UE 130 via the wireless link 135. An example of SRS and the position of the SRS in an uplink subframe in which the SRS are transmitted is shown in FIG. 2B along with positions of demodulation reference signals (DM-RS) for UEs 1-3. The SRS may be transmitted from the UE, for example, every 5 ms and is effectively a spread spectrum signal with significant processing gain. As is illustrated in FIG. 2B, multiple users, UEs 1-3 in FIG. 2B, can be multiplexed within the same SRS symbol in the same subframe. For example, up to 40 users in each 5 ms period can be accommodated—more than enough for a typical BS to RN carrying traffic ratio of 1/10.

In step S215, the BS 110 may determine a first signal measurement value based on the power indication received in step S210. The signal measurement value may be an estimation of at least one of a signal strength and a signal quality of the link 135 between the UE 130 and the BS 110 based on the quality/strength indicator received in step S210. For example, in step S215 the BS 110 may determine a signal to noise and interference ratio (SINR) value associated with the UE 130 based on an SRS value received from the UE 130 according to known methods. Though in the example method described above, signal measurements made at the BS 110 are based on SRS signals, additionally or alternatively, the first BS 110 may make signal quality/strength measurements based on other elements as well. For example, pilot signals in the physical uplink control channel (PUCCH) or the physical uplink shared channel (PUSCH) may be used by the first BS 110. Examples of the pilot signals will be discussed in greater detail below with reference to the RN 120.

In step S217, the BS 110 may send a power control command to the UE indicating transmit power level for the UE to use based on the first signal measurement determined in step S215. For example, the BS 110 may compare an SRS value received from the UE 130 to a target SRS value, and send a power control command to the UE indicating to adjust the transmit power at the UE based on the comparison.

In step S220, the BS 110 may send a signal measurement request to the first RN 120. For example, the signal measurement request may be an indication for the first RN 120 to measure quality/strength indicators received at the first RN 120 from the UE 130, for example SRS values, and to determine signal measurement values, for example SINR values, based on the SRS values received from the UE 130.

The signal measurement request may include, for example, information regarding one or more of a UE identifier such as a radio network temporary identifier (RNTI), a UE-specific periodic resource allocation of SRS, UE-specific sequence generation parameters of SRS, an UL time advance applied by the UE, a reference value for SINR denoted by SINR_ref, a measurement period for SINR_measurements, and a step size and value range parameters for quantization of SINR measurements. The information elements described above as being sent with the signal measurement request may be obtained by the BS 110 according to known methods. Alternatively, one or more of the information elements described above as being sent with the signal measurement request may instead be sent in a configuration message from the BS 110 to the first RN 120. Further, instead of exchanging RNTI in each signaling message, the RN and eNB may use a compressed UE identifier to reduce signaling load and to ease signaling for groups of users. For example, if the RN 120 is processing N users, for example where N<=256, then a compressed UE identifier 0 . . . N−1 could be used instead of, for example, a 16 bit RNTI. If a signaling message is for a group of UEs, then the information elements for UEs 0, 1, . . . , N−1 could simply be appended, so the UE identifier is signaled implicitly.

The BS 110 may send the signal measurement request via the wireless link 140. Though, in the example illustrated in FIG. 2A, the BS 110 sends a signal measurement request to one RN, RN 120, according to an example embodiment, the BS 110 may send signal measurement requests to any number of RNs within the communications network 100 that are associated with the BS 110. An example method for handling multiple RNs will be discussed in greater detail below with reference to FIG. 2C.

In step S225, the BS 110 may receive a second signal measurement value from the first RN 120. The second signal measurement value may be an estimation of at least one of a signal strength and a signal quality of the link 145 between the UE 130 and the RN 120 based on the quality/strength indicators received at the RN from the UE 130 as will be discussed in greater detail below with reference to FIGS. 3A and 3B. For example, the second signal measurement value may be an SINR value measured based on an SRS value received from the UE 130 at the first RN 120 in response to the signal measurement request sent in step S220. The second signal measurement may be received from the first RN 120 periodically, for example every 5 ms, via the wireless link 140. The BS 110 may maintain both instantaneous and average SINR. For example, calculating an average SINR over 100 subframes may be desirable to smooth out the fading variability.

Though in the example method described above, signal measurements made at the first RN 120 are based on SRS signals, additionally or alternatively, the first RN 120 may make signal quality/strength measurements based on other elements as well. For example, pilot signals in the physical uplink control channel (PUCCH) or the physical uplink shared channel (PUSCH) may be used by the first RN 120. For example, the RN 120 may use pilot signals in the PUSCH to evaluate CQI transmissions in order to make signal measurements. Alternative elements which may be used by the RN 120 to make signal measurements will be discussed in greater detail below with reference to step S320 in FIG. 3A. After step S225, the BS 110 proceeds to step S230.

In step S230, the BS 110 may determine a difference value representing a difference between the first and second signal measurement values discussed above with reference to steps S215 and S225, respectively. The BS 110 may determine a difference value based on the first signal measurement value received in step S217 and the second signal measurement value received in step S225. For example, the difference value, may be defined by equation (1):

deltaSINR_{SRS}=SINR_{SRS,r}−SINR_{SRS,d} (1)

where r and d denote the relay (UE to RN) and direct (UE to BS) links, SINR_{SRS,r} represents an RN based SINR which is the SINR value calculated based on the SRS value received at an RN, and SINR_{SRS,d} represents a BS based SINR which is the SINR value calculated based on the SRS value received at a BS, and deltaSINR_{SRS} represents the quality difference between the RN based SINR and the BS based SINR.

Alternatively, instead of using a difference between the RN based SINR and the BS based SINR, in step S230, the BS 110 may determine the difference value to be the second signal measurement value, for example the RN based SINR.

In step S235, the BS 110 compares the difference value determined in step S230 to a threshold value. The threshold value may be, for example, a value set by operations, administration & management (OA&M) signaling. To avoid frequent changes between do-serve and do-not-serve states, the threshold value may implement a hysteresis function. For example, the threshold value could be different depending on whether or not the attachment decision being made is a decision to change the UE 130 from a do-serve->do-not-serve state or a decision to change the UE 130 from a do-not serve->do-serve state.

In the case where the difference value is based on a plurality of types of UL strength/quality information, each of the types of UL strength/quality information may be compared to the threshold value used in step S235. In this case, it may be necessary to normalize the different types of UL strength/quality information as different types of UL signals may have different power offsets (PO). For example, if the second signal measurement value determined by the RN 120 in step S225 includes a combination of a first SINR value determined based on SRS values sent by the UE 130 and a second SINR value determined based on pilot signals of CQI data sent by the UE 130 in the PUCCH, the two types of SINR data should be normalized since SRS and CQI on PUCCH use different POs. For example, assuming the PO for SRS is higher than the PO for CQI on PUCCH, a normalized value for the second SINR value can be determined as follows:

SINR_meas_{—}2_norm=SINR_meas_{—}2+PO1−PO2 (dB) (2)

where SINR_meas_2_norm is the normalized SINR value for the second SINR value, PO1 is the PO for SRS, and PO2 is the PO for CQI on PUCCH.

In the case where the difference value is determined as the difference between the RN based SINR and the BS based SINR, deltaSINR is an indication of the reduction in UE transmit power spectral density (TxPSD) over the reporting period, e.g. 5 ms, if the BS 110 instructs the first RN 120 to serve the UE. The threshold then plays the role of distinguishing between small and large reductions in TxPSD. The larger the reduction the more likely it is that switching the UE to the RN from the eNB will be beneficial, not only from the DL perspective but also from the UL perspective.

In step S240, if the BS 110 determines that the difference value determined in step S230 is not greater than the threshold value, the BS 110 proceeds to step S245.

In step S245, the BS 110 sends an indication to the first RN 120 for the first RN 120 not to serve the UE 130. Alternatively, step S245 may be omitted, and no indication may be sent to the RN 120 in the event the BS 110 determines the difference value determined in step S230 is not greater than the threshold value in step S240.

If it is determined in step S240 that the difference value determined in step S230 is greater than the threshold value, the BS 110 proceeds to step S250.

In step S250, the BS 110 sends an indication to the first RN 120 for the first RN 120 to serve the UE 130, and transmission of a PDSCH for the UE 130 is switched from the BS 110 to the first RN 120.

Step S250 can be accomplished in a number of ways. As a first example, the RN 120 may be instructed to serve the UE 130 implicitly by overhearing communications between the BS 110 and the UE 130, for example scheduling decisions and data sent from the BS 110 to the UE 130 and/or ACK/NACKs sent from the UE 130 to the BS 110. The RN 120 may then determine to serve the UE 130 based on the overheard communications between the BS 110 and the UE 130.

As a second example, the BS 110 may explicitly command the RN 110 to serve the UE 130 by sending data to the RN and by sending signaling to the RN 120 over a command channel. The signaling may include, for example, one or more of a UE identifier, e.g. a radio network temporary identifier (RNTI) associated with the UE 130 in order to inform the RN to which UE to forward the data.

After step S250, the BS 110 then proceeds to step S255.

In step S255, the BS 110 sends a power reduction command to the UE 110 based on the difference value. For example, the BS 110 may send a power command instructing the UE 130 to set a TxPSD according to equation (3):

TxPSD_nonSRS=TxPSD_nonSRS−deltaSINR_{SRS} (3)

where TxPSD_nonSRS represents a TxPSD for non SRS symbols. The purpose of reducing TxPSD for non SRS symbols is to prevent the UE from using the same TxPSD used for communication with BS 110 for communication with the first RN 120, which is ostensibly closer, and thus, may achieve reception at an adequate quality level with a lower TxPSD. This reduction in TXPSD may result in a reduction in interference caused by the UE 130 at the first RN 120, BS 110 and other network nodes including, for example other BSs and RNs in wireless communications network 100.

Further, 3GPP standards allow the SRS to be transmitted at a different power offset relative to the other symbols of the subframe. The dynamic range of the deltaSINR SRS can be several dB, since this value accounts for the path loss difference between the BS 110 and the first RN 120 location relative to the UE 130. By transmitting SRS at a different power level, the TxPSD of the non-SRS symbols is set to an adequate level for their reception at the first RN 120 while the TxPSD for the SRS symbol is maintained at an adequate level for reception at the BS 110, which is an apparently adequate level for reception at the first RN 120 since the first RN 120 is ostensibly closer to the UE 130 than the BS 110. The difference between the non SRS and SRS TxPSD may be achieved by including in the power reduction command an SRS power offset parameter according to known methods.

After sending the power reduction command in step S255, the BS 110 may receive a message from the UE 130, for example a scheduling message, indicating the UE 130 has a larger power headroom (PH) as a result of the power reduction command. The BS 110 may then perform UL scheduling to determine a new spectral efficiency (SE) value. For example, the BS 110 may make UL scheduling decisions in a known manner taking into account cyclic redundancy check (CRC) events at a decoder of the RN 120, for example ACK/NACK messages, buffer filling, the new PH value, the estimated SINR at the RN 120, UE capabilities, quality of service (QoS), etc. where these parameters may be signaled from the UE directly or forwarded via the RN.

An example in which the BS 110 considers more than one RN in determining how to associate the UE 130 will now be discussed with reference to FIG. 2C. FIG. 2C is a flow chart illustrating a process for determining whether to associate a UE with a BS or one or more of a plurality of relay nodes according to an example embodiment from the viewpoint of BS 110.

The method illustrated in FIG. 2C will be explained with reference to an example in which the mobile 130, which is currently being served by the first RN 120, enters an area covered by the BS 110 and the second RN 125. Accordingly, using the method described below, the BS 110 will determine whether to change the association of the UE 130 to one of the BS 110 and the second RN 125, or to maintain the association of the UE 130 with the present RN, first RN 120. Though FIG. 2C is described below with reference to an example where there is only one RN in addition to the current RN, according to the example method illustrated in FIG. 2C, the UE 130 may enter a location covered by any number of additional RNs, and the BS 110 may make a determination of how to associate the UE taking all of the new RNs into account.

Referring to FIG. 2C, in step S1220, the BS 110 sends signal measurement requests to the one or more additional RNs, where additional RNs are RNs other than the RN currently serving the UE 130, RN 120. The signal measurement requests may be the same type of signal measurement request described above with reference to step S220 in FIG. 2A.

Accordingly, the BS 110 sends a signal measurement request to the second RN 125. For example, the signal measurement request may be an indication for the second RN 125 to measure SRS values received at the second RN 125 from the UE 130, and to determine signal measurement values, for example SINR values, based on the SRS values received from the UE 130.

Alternatively, the BS 110 can just send a signal measurement request to all RNs being considered for association, in including the RN presently serving the UE 130.

In step S1225, the BS 110 receives signal measurement value from RNs to which the signal measurement requests were sent in step S1220. For example, the BS 110 may receive a signal measurement value from the second RN 125 in response to the signal measurement request sent in step S1220. The one or more signal measurements received in step S1225 may each be of the same type discussed above with reference to step S225. For example, the signal measurement value may be an SINR value measured based on an SRS value received from the UE 130 at the second RN 125 in response to the signal measurement request sent in step S1220.

In step S1230, the BS 110 determines a plurality of difference values. In step S1230, the BS 110 determines difference values associated with each of the additional RNs. For example, the BS 110 may use equation (1) to determine a first difference value between a signal measurement associated with the current serving RN, the first RN 120, and a signal measurement associated with the additional RN, the second RN 125. Further, the BS 110 may determine a second difference value associated with the BS 110. For example, the BS 110 may use equation (1) to determine a second difference value between a signal measurement associated with the current serving RN, the first RN 120, and a signal measurement associated with the BS 110.

In step S1232, the BS 110 may select the network element (for example, from among the BS 110 and the additional RNs) associated with the highest difference value. As an alternative to selecting one network element, the BS 110 may select multiple network elements.

In step S1235, the BS 110 compares the difference values of the one or more network elements selected in step S1232 to a threshold value. The difference values may be the same type of difference value discussed above with reference to step S235 in FIG. 2A.

In step S1240, if the BS 110 determines that the difference values associated with the one or more network elements selected in step S1232 is not greater than the threshold value, the BS 110 proceeds to step S1245.

In step S1245, the BS 110 sends an indication to the additional RNs, for example the second RN 125, not to serve the UE 130, or, alternatively, the BS 110 sends no indication to the RN 125.

If it is determined in step S1240 that on or more of the difference values associated with the one or more network elements selected in step S1232 are greater than the threshold value, the BS 110 proceeds to step S1250.

In step S1250, the BS 110 sends an indication to the one or more network elements selected in step S1232, for example the second RN 125, to serve the UE 130, and the PDSCH for the UE 130 transmitted by the selected network elements according to known methods. For example, communications sent from the UE 130 to the BS 110 may then received by the second RN 125 and forwarded to the BS 110.

Accordingly, in the event the BS 110 determines, in step S1240, multiple RNs are associated with difference values that are greater than the threshold value, the BS 110 may associate the UE 130 with each of these RNs simultaneously. After step S1250, the BS 110 then proceeds to step S1255.

In step S1255, the BS 110 may send a power reduction command to the UE 110 based on the difference value associated with the one or more selected network element. For example, the BS 110 may send a power command instructing the UE 130 to set a TxPSD according to equation (3) in the same manner discussed above with reference to step S255 in FIG. 2A. In the event the UE 130 is associated with multiple RNs, the TxPSD of the UE 130 may be set, according to equation (3), based on the lowest difference value from among the multiple RNs in the same manner discussed above with reference to step S255 in FIG. 2A.

According to the methods discussed above with reference to FIGS. 2A-C, a BS included in a network having one or more type II RNs may make intelligent decisions about when to switch an association of a UE from the BS to one or more RNs, from an RN to a BS, or from an RN to one or more other RNs, in a manner that can increase or maximize a reduction in necessary transmit power experienced by the UE as a result of the switch.

### Operation of RN

Processes for determining whether to associate a UE with an RN according to an example embodiment will now be discussed below with reference to FIGS. 3A and 3B. According to an example embodiment, each of steps illustrated in FIGS. 3A and 3B may be performed by, for example, the RN 120 structured as illustrated in FIG. 1B, where the memory unit 156 may store executable instructions corresponding to each of the operations illustrated in FIGS. 3A and 3B, and the processor unit 158 is configured perform operations corresponding to each of the operations illustrated in FIGS. 3A and 3B. According to an example embodiment, transmitted data may be transmitted through the transmitting unit 152, and received data may be received through the receiving unit 154.

FIG. 3A is a flow chart illustrating a process for determining whether to associate a UE with a relay node according to an example embodiment from the viewpoint of the first RN 120. Referring to FIG. 3, in step S305 the first RN 120 receives a signal measurement request from the BS 110. For example, the signal measurement request may be an indication for the first RN 120 to measure signal strength and or quality indicators associated with the link 145 between the RN 120 and the UE 130. For example, the signal measurement request may be an indication for the first RN 120 to measure SRS values received at the first RN 120 from the UE 130, and to determine signal measurement values, for example SINR values, based on the SRS values received from the UE 130.

As is described above with reference to step S220 in FIG. 2, in step S305, the signal measurement request may include, for example, information regarding one or more of a UE identifier for the UE 130 such as a radio network temporary identifier (RNTI), a UE-specific periodic resource allocation of SRS, UE-specific sequence generation parameters of SRS, an UL time advance applied by UE, a reference value for SINR denoted by SINR_ref, a measurement period for SINR_measurements, and a step size and value range parameters for quantization of SINR_measurements. Alternatively, one or more of the information elements described above as being sent with the signal measurement request may instead be received in a configuration message from the BS 110 to the first RN 120.

In step S310, the first RN 120 may receive a signal quality/strength indicator from the UE 130. The signal quality/strength indicator may be an indication of one of a signal quality and a signal strength of the link 145 between the RN 120 and the UE 130, for example, an SRS value. The SRS values received at the first RN 120 in step S310 may be the same type of SRS values discussed above with reference to step S210 in FIG. 2A. As is described above with reference to step S210 in FIG. 2A, examples of SRS values sent from UEs are illustrated in FIG. 2B.

In step S315, the first RN 120 performs a signal measurement operation to determine at least one of a signal strength and a signal quality value based on the quality/strength indicator received in step S310. For example, the first RN 120 may perform a signal measurement operation on an SRS value received from the UE 130 in step S310 in order to determine a SINR value associated with the link between the UE 130 and the first RN 120, for example the wireless link 145. The first RN 120 may apply a measurement period indicated by the signal measurement request received from the BS 110 in step S305. Processing at the first RN 120 may include a filtering function that aims at finding the optimal UL symbol timing, as the time advance applied by UE for UL transmission may be adapted to the UE-BS link.

The measured SINR may be normalized according to equation (4):

SINR_norm=SINR_meas−SINR_ref (4)

where SINR_meas is the measured SINR, SINR_ref is the reference value for the SINR which may be received from the BS 110 in step S305, and SINR_norm is the normalized SINR. The measure SINR may be normalized, for example according to in dB units, and then quantized using the step size and value range parameters, for example with a range from −6 dB . . . +10 dB and 2 dB step size. The SINR measurements may be repeated periodically by the first RN 120. To facilitate step S315, it may be advantageous for the BS 110 to set the first RN 120 to be configured in receiving mode in periods, for example SC-FDMA symbols or subframes, that are used by the UE 130 for SRS transmission.

In step S320, the first RN 120 may send the signal measurement value determined in step S315 to the BS 110. For example, in step S320, the first RN 120 may report to the BS 110 the results of the signal measurement operation performed in step S315 by sending to the BS 110 an SINR value determined based on the SRS value received from the UE 130.

Though in the example method described above with reference to FIG. 3A, signal measurements made at the first RN 120 are based on SRS signals, as is noted above with reference to step S225 in FIG. 2A, additionally or alternatively, the first RN 120 may make signal measurements based on other elements as well. For example, pilot signals in the physical uplink control channel (PUCCH) for the detection of ACK/NACK or CQI, or pilot signals in the physical uplink shared channel (PUSCH) may be used by the first RN 120.

For example, the RN 120 may use pilot signals in the PUSCH. Typically, with the PUSCH the initial transmissions are received by Type II RN, but not the retransmissions, as the retransmissions are expected to be transmitted by the RN. Further, pilot signals of the channel quality/strength indicator (CQI) on PUCCH may be used. The CQI transmission on PUCCH can be periodic (for example, 2/5/10/20/40/80/160 ms periods), except for subframes containing PUSCH. A BS could configure the CQI reporting of a UE to use subframes that are not used for PUSCH transmission of a UE, so that the CQI reporting on PUCCH is strictly periodical. This would imply that CQI reporting period is a multiple of 8 ms so that the periodic CQI reporting would be rather rare (40/80/160 ms periods). If CQI reporting period is not a multiple of 8 ms, the CQI report will occasionally be multiplexed into the PUSCH and in these subframes the RN shall not compute SINR_measurement based on pilot signal transmitted on PUCCH.

Additionally pilot signals of UL acknowledgement information (ACK/NACK) on PUCCH may be used. For example, it can be assumed that RN receives UL ACK/NACK on PUCCH, therefore UL ACK/NACK can be used to assist the UE attachment decisions. Transmission of PUSCH and UL ACK/NACK may be irregular or absent for longer periods of time. Accordingly, it may be advantageous to base the UE attachment decisions on SRS and CQI on PUCCH UL signals. Pilot signals of PUSCH and/or UL ACK/NACK may be used in addition to SRS and/or pilot signals of CQI on PUCCH. Further, an RN, for example the first RN 120, may evaluate CQI data in a manner according to known methods by reading pilot signals used for demodulation of CQI or ACK/NACK or PUSCH.

In step S325, the first RN 120 receives from the BS 110 signaling indicating whether or not to serve the UE 130. As is discussed above with reference to steps S245 and S250, the signaling received in step S325 may include, for example, one or more of a UE identifier (RNTI) associated with the UE 130, service indicator for UE, for example “serve the UE”/“do not serve the UE”, and a measurement indicator for the UE, for example “continue to monitor the UE”/“stop monitoring the UE”.

In step S330, the first RN 120 determines whether or not to serve the UE 130 based on the signaling received in step S325. If the signaling includes an indication for the first RN 120 to serve the UE 130, transmission of the PDSCH for the UE 130 is switched from the BS 110 to the first RN 120 according to known methods, and communications from the UE 130 to the BS 110 are received by the first RN 120 and forwarded to the BS 110. If the signaling includes an indication for the first RN 120 not to serve the UE 130, the RN 120 does not serve the UE 130. Alternatively, in the event the BS 110 determines the RN 120 will not serve the UE 130, the BS 110 may not send any indication to the RN 120 regarding serving the UE 130.

FIG. 3A illustrates an example operation of an RN in which a decision on whether to serve a UE is made by a BS and communicated to an RN. FIG. 3B illustrates an alternative to the example operation of an RN illustrated in FIG. 3A wherein after the first RN 120 sends the signal measurement to the BS 110 in step S320, the first RN 120 makes a decision on whether to serve a UE.

Referring to FIG. 3B, after the signal measurements to the BS 110 in step S320, the RN 120 proceeds to step S1325. In step S1325, the RN 120 compares the signal measurement value generated based on the signal measurement operation performed in step S315 to a threshold. The threshold value may be a value received from the BS 110, or a value determined at the RN based on values received from the BS 110. For example, the threshold may an SINR_ref value received from the BS 110 in the manner discussed above with reference to step S305 in FIG. 3A.

In step S1330 the first RN 120 determines whether or not to serve the UE 130 based on the comparison performed in step S1325. For example, if the comparison indicates the signal measurement value exceeds the threshold, the first RN 120 may decide to serve the UE 130.

In step S1335, the RN 120 sends the determination made in step S1330 to the BS 110. For example, if the RN 120 decided to serve the UE 130 in step S1330, in step S1335 the RN 120 may send a message to the BS 110 indicating that the RN 120 is serving the UE 130. At this point, the RN 120 may transfer data for the UE 130 from the BS 110. The RN 120 may begin transmission of the PDSCH for the UE 130 according to known methods, and communications from the UE 130 to the BS 110 may be received by the first RN 120 and forwarded to the BS 110.

Further, if the RN 120 decided not to serve the UE 130 in step S1330, in step S1335 the RN 120 may send a message to the BS 110 indicating that the RN 120 is not serving the UE 130. Alternatively, in the event the RN 120 determines not to serve the UE 130, the RN 120 may not send any indication to the BS 110 regarding serving the UE 130.

According to the methods discussed above with reference to FIGS. 3A-B, a type II RN that is associated with a BS may generate meaningful signal strength and/or quality information regarding a UE within the coverage area of the RN. The RN may then forward the signal strength/quality information to the BS so the BS can make intelligent decisions about when to switch an association of a UE from the BS to the RN, or when to switch the association of the UE from the RN to another RN, in a manner that can increase or maximize a reduction in necessary transmit power experienced by the UE as a result of the switch.

### Operation of UE

FIG. 4 is a flow chart illustrating a process for determining whether to associate a UE with a relay node according to an example embodiment from the viewpoint of the UE 130. Referring to FIG. 4, in step S405 the BS 110 performs a call set up operation with the UE 130 according to known methods.

In step S410, the UE 130 sends a signal quality/strength indicator to the BS 110. The quality/strength indicator may be a value which can be used to determine at least one of a signal quality and a signal strength of a link between the UE 130 and another element, for example, an SRS value generated by the UE 130 according to known methods.

In step S415, the UE receives a command to reduce transmit power based on the quality/strength indicator sent in step S410. For example, as a result of the SRS value sent in step S410, the BS 110 may determine to switch an association of the UE 110 to the RN 120 based on a quality/strength difference value calculated at the BS 110 using the SRS value. The switch in association may not be apparent to the UE 130 due to the RN 120 being a type II RN which is transparent to the UE 130. However, the BS 110 issues the power reduction command to the UE 130 because the UE 130 is now associated with the RN 120, which is ostensibly closer to the UE 130 and thus, requires less TxPSD on the part of the UE 130 for adequate signal quality.

In step S420, the UE 130 reduces its TxPSD based on the power reduction command received in step S415 in accordance with known methods. After the UE 130 reduces its TxPSD, the UE 130 may send a subsequent message to the BS 110 via the RN 120 indicating to the BS 110 that the UE has a increased power headroom (PH). The BS may use this information to determine a new spectral efficiency (SE) value in the manner discussed above with reference to step S255.

According to the methods discussed above with reference to FIG. 4, a UE in a network including a BS and at least one RN, for example a type II RN, may facilitate the generation of meaningful information at the RN regarding at least one of a signal strength and a signal quality between the UE and the RN. The RN may then forward the signal strength/quality data to the BS so the BS can make intelligent decisions about when to switch an association of a UE from the BS to the RN, or when to switch the association of the UE from the RN to another RN, in a manner that can increase or maximize a reduction in necessary transmit power, experienced by the UE as a result of the switch.

### Example Operation Sequence

FIG. 5 is communications flow diagram illustrating an example sequence of operations in a communication network implementing a process of handling a mobile terminated call according to an example embodiment. The communications diagram will now be explained with reference to the UE 130, RN 120 and BS 110 of the communications network 100 in FIG. 1A.

Referring to FIG. 5, in step S505 the UE 130 and the BS 110 perforin a call set up operation according to known methods.

In step S510, the UE 130 begins sending SRS values to the BS 110 periodically, for example every 5 ms. The RN 120 is also capable of receiving the SRS values sent from the UE 130.

In step S515, the BS 110 sends a power control command to the UE 130 in the same manner discussed above with reference to step S217 in FIG. 2A.

In step S520, the BS 10 sends a signal measurement request to the RN 120 in the manner discussed above with reference to step S220 in FIG. 2.

In step S525, the RN 120 measures the SRS value sent from the UE 130, in response to the signal measurement request sent in step S515, and determines a RN based a signal measurement value in the manner discussed above with reference to step S315 in FIG. 3A.

In step S530, the BS 110 measures the SRS value sent from the UE 130 and determines a BS based signal measurement value in the manner discussed above with reference to step S215 in FIG. 2A.

In step S535, the RN 120 reports the RN based signal measurement to the BS 110 in the manner discussed above with reference to step S320 in FIG. 3A.

In step S540, the BS 110 determines a deltaSINR value based on the RN based signal measurement and the BS based signal measurement in the manner discussed above with reference to step S230 in FIG. 2. In the example illustrated in FIG. 5, it will be assumed that the SINR value of the RN 120 is greater than the SINR value of the BS 110.

In step S545, the BS 110 compares the deltaSINR value to a threshold value in the same manner discussed above with reference to step S235 in FIG. 2. In the example illustrated in FIG. 5, it will be assumed that the deltaSINR value is greater than the threshold.

In step S550, the BS 110 determines whether to switch the association of the UE 130 from the BS 110 to the RN 120. In the example illustrated in FIG. 5, since the deltaSINR value is greater than the threshold, the BS 110 does determine to switch the association of the UE 130 from the BS 110 to the RN 120.

In step S555, the BS 110 sends an indication to the RN 120 for the RN 120 to serve the UE 130 in the manner discussed above with reference to step S250.

In step S560, the association of the UE 130 is switched from the BS 110 to the RN 120 according to known methods. Thus, the RN 120 begins transmitting the PDSCH, and forwarding packets received from the UE 130 to the BS 110.

In step S565, BS 110 sends a power reduction command to the UE 130 instructing the UE 130 to reduce its non-SRS TxPSD in the manner discussed above with reference to step S255.

In step S570, the UE 130 reduces its TxPSD in response to the power reduction command sent in step S565.

In step S575, the UE 130 sends a message to the BS 110 indicating the UE 130 has a higher PH value in the manner discussed above with reference to step S420 in FIG. 4.

In step S580, the BS 110 determines a new SE value based on the PH value received from the UE in step S575. The new SE value is determined in the manner discussed above with reference to step S255 in FIG. 2A.

Though the scenario illustrated in FIG. 5 illustrates a particular sequence of messages, the scenario illustrated in FIG. 5 is provided only as an example and any number of different message sequences may occur in accordance example embodiments of the present invention.

The invention being thus described, it will be obvious that the same may be varied in many ways. Such variations are not to be regarded as a departure from the invention, and all such modifications are intended to be included within the scope of the invention.

What is claimed:

1. A method for handling association of a user equipment (UE) in a communications network including a base station (BS) and a first relay node (RN), the method comprising:
sending a request to the first RN for the first RN to perfoi in a signal measurement operation, the request including an indication to measure at least one of a signal strength and signal quality of a link between the RN and the UE;
receiving a first signal measurement value from the first RN;
determining whether to associate the UE with the first RN based on the first signal measurement value.

2. The method of claim 1, wherein the request is a request for the RN to perform a signal measurement operation based on data received at the RN from the UE, the data including one or more sounding reference signal (SRS) values.

3. The method of claim 1, wherein the request is a request for the RN to perform a signal measurement operation based on data received at the RN from the UE, the data including pilot signals received in at least one of a physical uplink control channel (PUCCH) or a physical uplink shared channel (PUSCH).

4. The method of claim 1, further comprising:
generating a comparison result based on the first signal measurement value and a threshold,
wherein the determining step includes determining whether to associate the UE with the first RN based on the comparison result.

5. The method of claim 4, further comprising:
sending an indication to the first RN to serve the UE, if the determining step determines to associate the UE with the first RN; and
sending a power command to the UE instructing the UE to reduce a transmit power of the UE, if the determining step determines to associate the UE with the first RN.

6. The method of claim 4, further comprising:
performing a signal measurement operation at the BS measuring at least one of a signal strength and signal quality of a link between the RN and the UE;
generating a second signal measurement value based on the signal measurement operation performed at the BS; and
generating a difference value based on a difference between the first signal measurement value and the second signal measurement value,
wherein the generating the comparison result step includes generating the comparison result based on the difference value and the threshold.

7. The method of claim 6, further comprising:
sending an indication to the first RN to serve the UE, if the determining step determines to associate the UE with the first RN; and
sending a power command to the UE instructing the UE to reduce a transmit power of the UE, if the determining step determines to associate the UE with the first RN.

8. The method of claim 7, wherein the power command includes instructions for the UE to reduce the transmit power of the UE by an amount determined based on the difference value.

9. The method of claim 4, wherein the first RN is one of a plurality of RNs included in the communications network,
the sending step includes sending a request to each of the plurality of RNs for each of the plurality of RNs to perform signal measurement operations,
the receiving step includes receiving a first signal measurement value from each of the plurality of RNs,
the generating a comparison result step includes generating a plurality of comparison results based on the first signal measurement values for each of the plurality of RNs and the threshold, and
the determining step includes determining whether to associate the UE with one or more selected RNs from among the plurality of RNs based on the plurality of comparison results.

10. The method of claim 9, further comprising:
sending serve indications to the one or more RNs the determining step determined to associate the UE with, each serve indication indicating the RN is to serve the UE; and
sending a power command to the UE instructing the UE to reduce a transmit power of the UE, if the determining step determines to associate the UE with at least one of the selected RNs.

11. The method of claim 1, wherein the first RN is a type II RN.

12. A method for handling association of a user equipment (UE) in a communications network including a base station (BS) and a relay node (RN), the method comprising:
receiving a request from the BS requesting the RN to perform a signal measurement operation, the request including an indication to measure a signal strength of a link between the RN and the UE;
receiving a quality/strength indicator from the UE;
performing the signal measurement operation based on the quality/strength indicator to generate a signal measurement value;
sending the signal measurement value to the base station.

13. The method of claim 12, further comprising:
receiving an indication to serve the UE from the BS at the RN based on the signal measurement value sent from the RN to the BS;
serving the UE by performing at least one of forwarding communications data received from the BS to the UE and forwarding communications data received from the UE to the BS.

14. The method of claim 12, further comprising:
comparing the signal measurement value to a threshold value at the RN;
determining whether to serve the UE based on the comparison at the RN;
sending an indication of the determination from the RN to the BS;
receiving data for the UE from the BS at the RN if the indication indicates the RN determined to serve the UE.

15. The method of claim 12, wherein the quality/strength indicator includes one or more sounding reference signals (SRS) values.

16. The method of claim 12, wherein the quality/strength indicator includes one or more pilot signals received in at least one of a physical uplink control channel (PUCCH) or a physical uplink shared channel (PUSCH).

17. A method for handling association of a user equipment (UE) in a communications network including a base station (BS) and a relay node (RN), the method comprising:
sending a signal quality/strength indicator;
receiving, at the UE from the BS, an indication to reduce a transmit power level of the UE, the indication being based on a signal measurement performed at the RN based on the signal quality/strength indicator;
reducing the transmit power at the UE based on the indication.

18. The method of claim 17, wherein the signal quality/strength indicator includes one or more sounding reference signal (SRS) values.

19. An network apparatus for providing wireless communications between a base station (BS) and a user equipment (UE) in a wireless communications network, the apparatus comprising:
a receiver unit configured to receive data from the BS and the UE;
a transmitting unit configured to transmit data to the BS and the UE;
a memory unit configured to store parameters corresponding with at least one of signal power and signal quality measurements associated with the wireless communications network; and
a processing unit coupled to the transmitting unit, the receiving unit, and the memory unit and configured to control operations associated with evaluating at least one of the signal quality and the signal strength including,
receiving a request from the BS requesting the RN to perform a signal measurement operation, the request including an indication to measure at least one of a signal strength and a signal quality of a link between the RN and the UE,
receiving a quality/strength indicator from the UE,
performing the signal measurement operation based on the quality/strength indicator to generate a signal measurement value, and
sending the signal measurement value to the BS.
